(19) United States
(12) Patent Application Publication
(10) Pub. No.: US 2017/0331776 A1
(43) Pub. Date: Nov. 16, 2017

(54) DECOMPOSED LAYOUTS FOR ATTENTION MANAGEMENT

(71) Applicant: International Business Machines Corporation, Armonk, NY (US)

(72) Inventors: Paul R. Bastide, Boxford, MA (US); Matthew E. Broomhall, Goffstown, NH (US); Robert E. Loredo, North Miami Beach, FL (US)

(21) Appl. No.: 15/150,468

(22) Filed: May 10, 2016

(51) Int. Cl. H04L 12/58; G06F 3/0484

(52) U.S. Cl. CPC H04L 51/22; G06F 3/04842; H04L 51/32

(57) ABSTRACT

A method for presenting a plurality of electronic content based on a uniqueness criterion is presented. The method may include identifying a plurality of content fields from the plurality of electronic content. The method may also include extracting a plurality of field data from the identified plurality of content fields. The method may then include determining the uniqueness criterion for each field within the extracted plurality of field data. The method may further include generating a plurality of visual indicators based on the identified plurality of content fields and the determined uniqueness criterion. The method may also include presenting the generated plurality of visual indicators in a decomposed view on an electronic display.

### BACKGROUND

The present invention relates generally to the field of computing, and more particularly to electronic message presentation.

Online social networks, project management systems, and mail clients may overwhelm users with detailed and difficult to digest lists of data. The focus of users may by lost and difficult to regain as a result of the overwhelming volume of data presented to users.

### SUMMARY

According to one exemplary embodiment, a method for presenting a plurality of electronic content based on a uniqueness criterion is provided. The method may include identifying a plurality of content fields from the plurality of electronic content. The method may also include extracting a plurality of field data from the identified plurality of content fields. The method may then include determining the uniqueness criterion for each field within the extracted plurality of field data. The method may further include generating a plurality of visual indicators based on the identified plurality of content fields and the determined uniqueness criterion. The method may also include presenting the generated plurality of visual indicators in a decomposed view on an electronic display.

According to another exemplary embodiment, a computer system for presenting a plurality of electronic content based on a uniqueness criterion is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include identifying a plurality of content fields from the plurality of electronic content. The method may also include extracting a plurality of field data from the identified plurality of content fields. The method may then include determining the uniqueness criterion for each field within the extracted plurality of field data. The method may further include generating a plurality of visual indicators based on the identified plurality of content fields and the determined uniqueness criterion. The method may also include presenting the generated plurality of visual indicators in a decomposed view on an electronic display.

According to yet another exemplary embodiment, a computer program product for presenting a plurality of electronic content based on a uniqueness criterion is provided. The computer program product may include one or more computer-readable storage devices and program instructions stored on at least one of the one or more tangible storage devices, the program instructions executable by a processor. The computer program product may include program instructions to identify a plurality of content fields from the plurality of electronic content. The computer program product may also include program instructions to extract a plurality of field data from the identified plurality of content fields. The computer program product may then include program instructions to determine the uniqueness criterion for each field within the extracted plurality of field data. The computer program product may further include program instructions to generate a plurality of visual indicators based on the identified plurality of content fields and the determined uniqueness criterion. The computer program product may also include program instructions to present the generated plurality of visual indicators in a decomposed view on an electronic display.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 is an operational flowchart illustrating a process for decomposed layout generation according to at least one embodiment;

FIG. 3 is a block diagram illustrating an exemplary email client interface according to at least one embodiment;

FIG. 4 is a block diagram illustrating an exemplary decomposed layout overlay according to at least one embodiment;

FIG. 5 is a block diagram illustrating an exemplary regenerated decomposed layout overlay altered in response to a user selection according to at least one embodiment;

FIG. 6 is a block diagram of internal and external components of computers and servers depicted in FIG. 1 according to at least one embodiment;

FIG. 7 is a block diagram of an illustrative cloud computing environment including the computer system depicted in FIG. 1, in accordance with an embodiment of the present disclosure; and

FIG. 8 is a block diagram of functional layers of the illustrative cloud computing environment of FIG. 7, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method and program product for decomposed layouts. As such, the present embodiment has the capacity to improve the technical field of electronic message presentation by analyzing lists of messages and presenting decomposed layouts representing the important information derived from the analysis. More specifically, a decomposed layout may be generated in response to determining that a message threshold has been exceeded, whereby the decomposed layout may be generated by analyzing the content of the messages, extracting mail/social items and related fields from the messages, determining unique values for each field, and then building the decomposed view.

As described previously, online social networks, project management systems, and mail clients may overwhelm users with detailed and difficult to digest lists of data. The focus of users may by lost and difficult to regain as a result of the overwhelming volume of data presented to users. With dynamic updates and constantly refreshing tables of information, there arises the problem of presenting the correct level of information for a user to efficiently process a list of information (e.g., email).

Therefore, it may be advantageous to, among other things, provide a way to efficiently generate and present useful information representing complex lists to a user.

According to at least one embodiment, a source list may be selected as the basis for generating a decomposed layout for attention management. The source list may include email, social items, collaborative items, project management data, to-do lists, instant messages, short message services, blogs, web pages, data lists, news feeds, and so on. Once the source list is identified (e.g., by user interaction with a graphical user interface (GUI)), the source list may be analyzed. Unique fields (e.g., the name of a sender or a subject line) may be extracted based on the analysis performed and then the extracted fields may be normalized using known methods. Once the unique fields are extracted, a decomposed layout view may be generated based on the number of times specific data appeared in the source list. Furthermore, the decomposed layout may organize the layout into columns of related data (e.g., a column to represent email senders). The decomposed layout may present to the user columns with visual indicators (e.g., rectangles or other shapes) that represent fields of data that appear frequently in the source list as well as altering the characteristics of the visual indicators (e.g., color saturation of the indicator rectangle) to convey relative frequency to the user. The decomposed layout may then be presented to the user. According to at least one implementation, the decomposed layout may also detect and respond to user input (e.g., clicking on a visual indicator). In response to user input, the decomposed layout may dynamically change to refine the data presented to the user such that the user may be able to refine the data presented in the decomposed layout. Additionally, the decomposed layout may respond to user input corresponding with a visual indicator by displaying the list items (e.g., email messages) the visual indicator represents.

For example, a decomposed layout for an email inbox may be generated by first analyzing each message in the inbox. The inbox may present a list of messages by displaying the sender, the subject line, and the time of receipt. The sender for each message may be read and the number of times each sender appears in the inbox may be counted. Similarly, certain times may be counted, such as how many messages were received per day, and the number of times subjects appeared in the subject lines of messages in the inbox. Thereafter, a percentage may be calculated and assigned to each unique field, such as the unique sender field of “Samantha.” Thus, if “Samantha” was the sender for five email messages out of ten, 50% may be calculated and assigned as the percentage of messages that have “Samantha” as the sender. After all of the fields within the email inbox have been similarly analyzed and assigned percentages, a decomposed layout may be generated with visual indicators drawn to indicate relative contribution to a column. The columns in the decomposed layout for the inbox may include a sender column, a subject column, and a date column. The visual indicators in the decomposed layout may be rectangles that are sized to indicate the relative contribution of the field. Within the sender column, a rectangle corresponding to the sender “Samantha” may be drawn to fill half the height of the column since messages having “Samantha” as the sender make up half of the inbox. Additional visual cues (i.e., visual characteristics) may be tuned to signify the relative contribution of a field, such as color intensity (e.g., more intense colors may indicate higher relative contribution) and/or text size (e.g., larger fonts may indicate higher relative contribution).

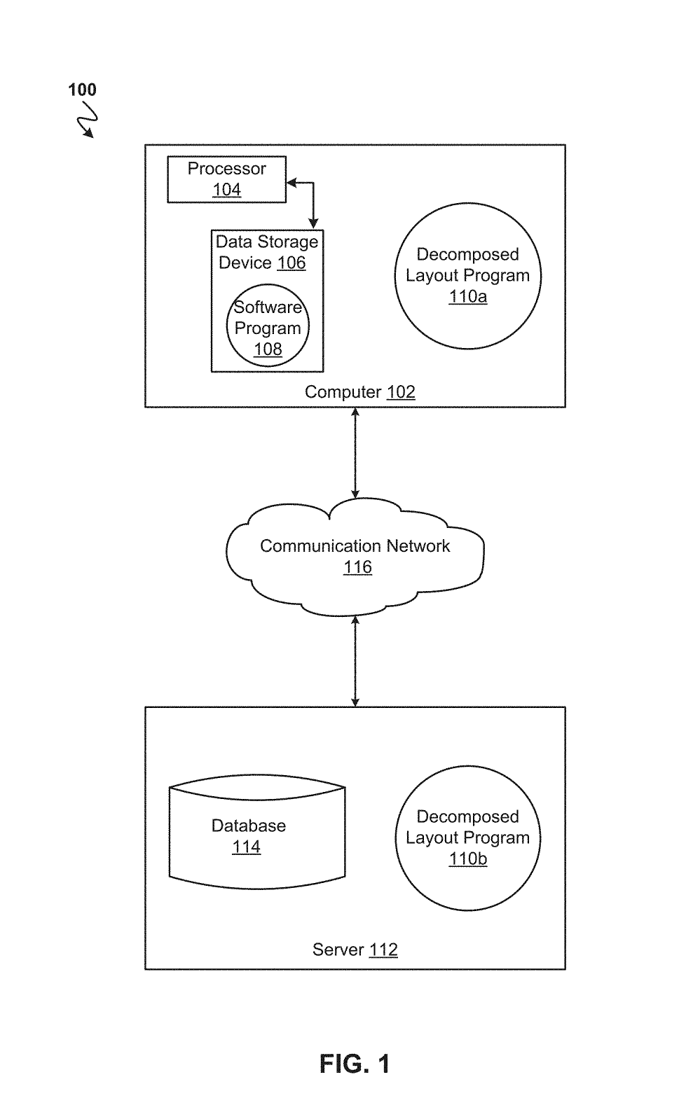

Referring to FIG. 1, an exemplary networked computer environment 100 in accordance with one embodiment is depicted. The networked computer environment 100 may include a computer 102 with a processor 104 and a data storage device 106 that is enabled to run a software program 108 and a decomposed layout program 110a. The networked computer environment 100 may also include a server 112 that is enabled to run a decomposed layout program 110b that may interact with a database 114 and a communication network 116. The networked computer environment 100 may include a plurality of computers 102 and servers 112, only one of which is shown. The communication network 116 may include various types of communication networks, such as a wide area network (WAN), local area network (LAN), a telecommunication network, a wireless network, a public switched network and/or a satellite network. It should be appreciated that FIG. 1 provides only an illustration of one implementation and does not imply any limitations with regard to the environments in which different embodiments may be implemented. Many modifications to the depicted environments may be made based on design and implementation requirements.

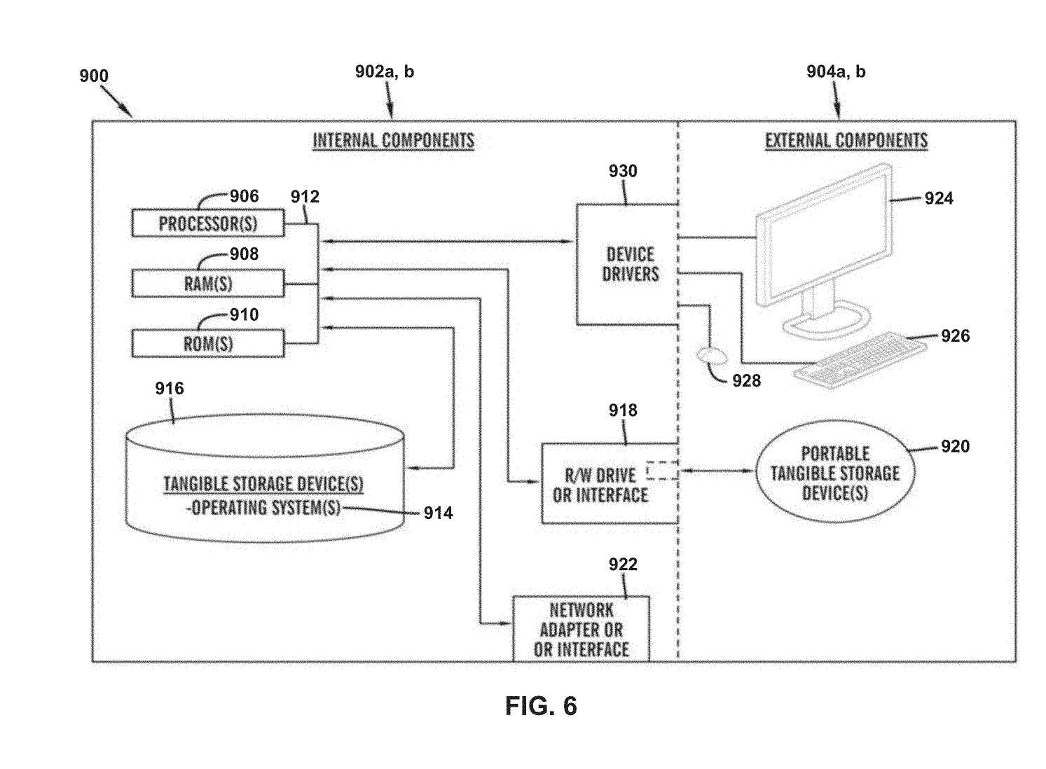

The client computer 102 may communicate with the server computer 112 via the communications network 116. The communications network 116 may include connections, such as wire, wireless communication links, or fiber optic cables. As will be discussed with reference to FIG. 6, server computer 112 may include internal components 902a and external components 904a, respectively, and client computer 102 may include internal components 902b and external components 904b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing devices capable of running a program, accessing a network, and accessing a database 114. According to various implementations of the present embodiment, the decomposed layout program 110a, 110b may interact with a database 114 that may be embedded in various storage devices, such as, but not limited to a computer/mobile device 102, a networked server 112, or a cloud storage service.

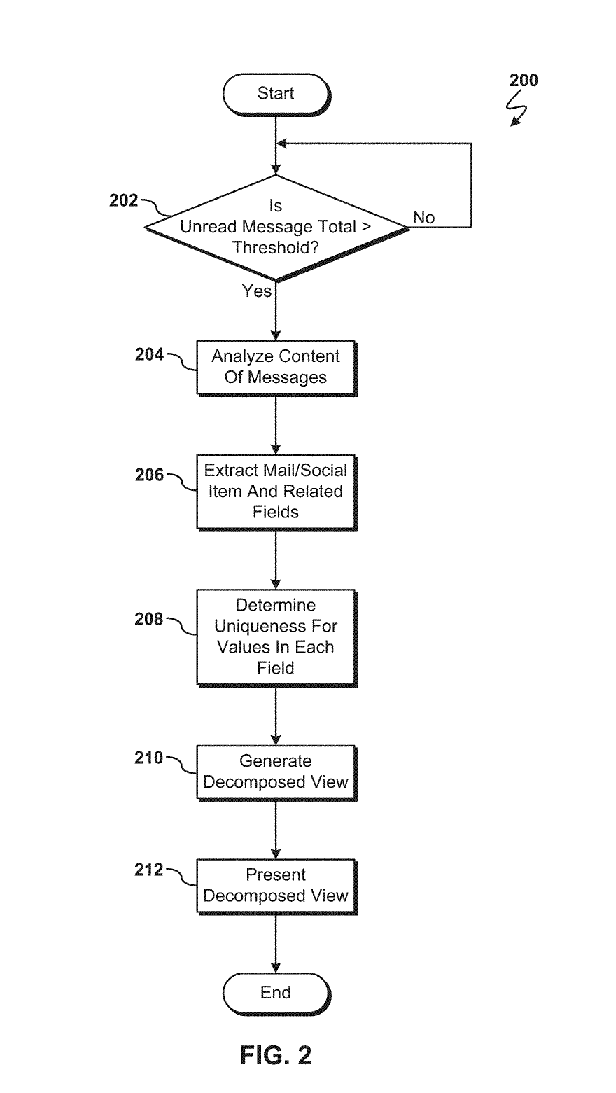

According to the present embodiment, a user using a client computer 102 or a server computer 112 may use the decomposed layout program 110a, 110b (respectively) for attention management by generating a decomposed layout based on a list of information. The decomposed layout method is explained in more detail below with respect to FIGS. 2-5.

Referring now to FIG. 2, an operational flowchart illustrating the exemplary decomposed layout generation process 200 used by the decomposed layout program 110a and 110b according to at least one embodiment is depicted.

At 202, the decomposed layout generation process 200 determines if the unread message total exceeds a threshold. The unread message total may be determined by querying a software program (e.g., 108) handling the messages (i.e., source list) identified as the basis for generating the decomposed layout. Once the number of unread messages is determined, the value may be stored in a data repository, such as a database (e.g., 114). The query for the number of unread messages may be implemented according to the program architecture of the program handling the messages. For example, a query may be a made using the application program interface (API) specific to the message program. Once the number of unread messages is determined, the number of unread messages may be compared with a threshold value. The threshold value may be a value set by the user, a program, dynamically based on the history of the user, some other method or combination of methods. In instances when the list used for the basis of the decomposed layout does not relate to messages, other metrics may be used to determine when the list exceeds a threshold, such as when the number of items in a list exceeds the threshold value.

For example, if an email client inbox has 13 messages and 11 unread messages, the number of unread messages may be queried from the email client. Once the query result of 11 is returned, the number of unread messages may be stored in a database 114. Thereafter, the threshold value of 10 may be retrieved from a data repository. The threshold value 10 may then be compared with the number of unread messages 11. The decomposed layout generation process 200 will then determine that the number of unread messages exceeds the threshold value (i.e., 11>10).

If the decomposed layout generation process 200 determines that the number of unread messages does not exceed the threshold value, then the decomposed layout generation process 200 will return to 202 to continue to query the number of unread messages and determine if the unread message total exceeds the threshold value.

However, if the decomposed layout generation process 200 determined that the number of unread messages exceeds the threshold value at 202, then the decomposed layout generation process 200 will analyze the content of the messages at 204. The messages may be analyzed individually to identify the value of fields associated with each message. The value of a field may include a text string with letter, numbers, or other symbols. For example, if the analyzed messages are emails, each message may have fields for sender, subject, and date. The sender field may have a text string indicating a name or other identifier of the entity that sent the message. The subject field may have a text string that includes the subject line of the email. Finally, the date may include a text string indicating the date the email message was received. The message structure and categories of fields (e.g., sender category) may be predefined or may be dynamically determined based on comparison to templates or by other known methods. The analysis of messages may be limited to messages displayed within a single view (e.g., ten items), a page (e.g., twenty items), or all items (e.g., an entire inbox).

Then, at 206, mail/social items and related fields are extracted from the messages. Leveraging the architecture of the message handling program (e.g., through an API), the values of the fields of the messages may be extracted from the message and the extracted values may be stored in a data repository, such as a data storage device 106. Additionally, after the values of the message fields have been extracted, the field value data (e.g., text strings) may be normalized before or after being stored. Known normalizing algorithms may be used to strip out irrelevant data, such as superfluous characters (e.g., “Re:” or “Fw:” in the case of email subject lines). Other field data may be normalized to make the field data more consistent. For example, date timestamps may be normalized by changing 30 November to November 30 or June 03 to Monday. Field value data may be extracted from each message sequentially until all messages have been processed.

For example, the fields of email messages in an inbox may have been determined previously at 204 to include a sender field, a subject field, and a date field. The field values of an email message in the inbox may have the values of “Samantha” for the sender field, “Re: Diamonds” for the subject field, and “Sunday” for the date field. The field values may then be extracted by reading the values for each field associated with the email and storing the read field values in an array or other data structure corresponding to a particular field. When the field value for the sender field is read, the text string value of “Samantha” may then be stored in an array containing sender field data for all of the email messages in the inbox. Similarly, the subject field may be read and the text string value of “Re: Diamonds” may be stored in a subject array. The subject field value may also be normalized before storage into the subject array by stripping the “Re:” characters from the text string value, the value “Diamonds” may be stored in the subject array. Finally, the date field may be read and the text string value of “Sunday” may be stored in a date array. Based on the previous analysis, the decomposed layout generation process 200 may have determined that there are three fields for each message and thus after reading the three fields, the decomposed layout generation process 200 may repeat the extraction step for the next message, if any messages remain.

At 208, the uniqueness for the values in each field are determined. The number of times each unique field value (e.g., “Samantha” for the sender field) occurs (i.e., uniqueness criterion) may be determined as a basis for calculating the proportion each unique value appears with respect to the total number of messages. The calculation may determine the percentage of the total field category (e.g., sender) that is made up of a unique field value (e.g., “Samantha”). For example, if five occurrences of “Samantha” appear out of the total ten messages, “Samantha” will be the sender field value for 50% of the total messages.

According to at least one implementation, the data structure storing the field value data may be searched to count the number of times a field value occurs. For example, a sender array may contain the field values of: “Samantha,” “Samantha,” “Samantha,” “Gary,” “Jane,” “Renata,” “Larry,” “Samantha,” “Samantha,” and “Jane.” A new sender counter array may then be initialized to contain unique value/number of occurrences tuples for each unique field. Once the first value in the sender array is read (i.e., “Samantha”), the sender counter array may be searched for an element corresponding to the value “Samantha.” Since the value “Samantha” is not found in the sender counter array, the tuple “Samantha” and the value 1 may be added to the sender counter array (i.e., stored as “Samantha, 1”). Thereafter, the second value in the sender array may be read (i.e., “Samantha”) and the sender counter array is searched for the read value “Samantha.” Since “Samantha” is already in the sender counter array, the value of “Samantha” may not be added. However, the value of 1 in the tuple will incremented to 2 to indicate that a second occurrence of “Samantha” was found. The process of searching through the sender array one-by-one may continue until the sender array has been fully searched.

According to at least one other implementation, instances of a unique field value may be counted as the field values are extracted, as described previously at 206.

Next, at 210, the decomposed view is generated. Based on the uniqueness of the field values, visual indicators may be generated to represent the number of occurrences of each unique field value. Visual indicators may be in the form of shapes presented to the user, such as rectangles, corresponding to each unique field value. Furthermore, the visual indicators may include a label identifying the unique field value (e.g., “Samantha”). The visual indicators may also be generated with different visual cues tuned (i.e., altered) to signify the number of field value occurrences. Visual cues may include the size of the visual indicator, the size of the font used for the field value label, color characteristics of the visual indicator (e.g., tint or saturation), the pattern of the visual indicator, and font characteristics (e.g., bold or italic). For example, the visual indicator corresponding to the field value with the highest number of occurrences (e.g., “Samantha”) may have a field value label font size that is larger than the other field value labels in the same field (e.g., sender) as a visual cue to indicate the greater contribution for the field value. Additionally, the visual indicator size may be proportional to the contribution the field value has to the total number of messages. For example, if the field value “Samantha” is present in five out of ten total messages (i.e., half of the total messages), a visual indicator rectangle may be generated having a height equal to half of the total vertical space available in the decomposed view, in the case of a vertically-oriented view.

The visual indicators may also be arranged in order of relative contribution to the total messages. For example, in a vertical orientation, the visual indicator corresponding with the field value for a sender having the most occurrences may be placed at the bottom of the decomposed view, the visual indicator corresponding with the field value for a sender having the second most occurrences may be placed above the visual indicator corresponding to the sender having the most occurrences in the decomposed view, as so forth. Furthermore, field values having few occurrences may be combined into a single catchall visual indicator labelled as “Other,” thus focusing the attention of a user to field values that more frequently appear in the messages or list. Unique field values may also be grouped into a single visual indicator based on other considerations, such as grouping messages based on date. For example, grouping messages received on a certain day into a single visual indicator for the day (e.g., “Saturday”), or grouping messages received by week, month, and so forth. Unique field values may also be grouped by similar subject matter. Thus, two field values may be grouped together despite being distinct since the field values relate closely to one another. For example, a unique field may include “Food Available” while another field value may include the value of “Office Lunch.” Since both “Food” and “Lunch” are related, the two field values may be combined into a single visual indicator. Determining if field values are related may be accomplished using known methods (e.g., searching lists of synonyms or dictionaries). Furthermore, the label for visual indicator for the grouped field values may be based on the field value in the group with the most occurrences, the first field value that occurred, or by some other method.

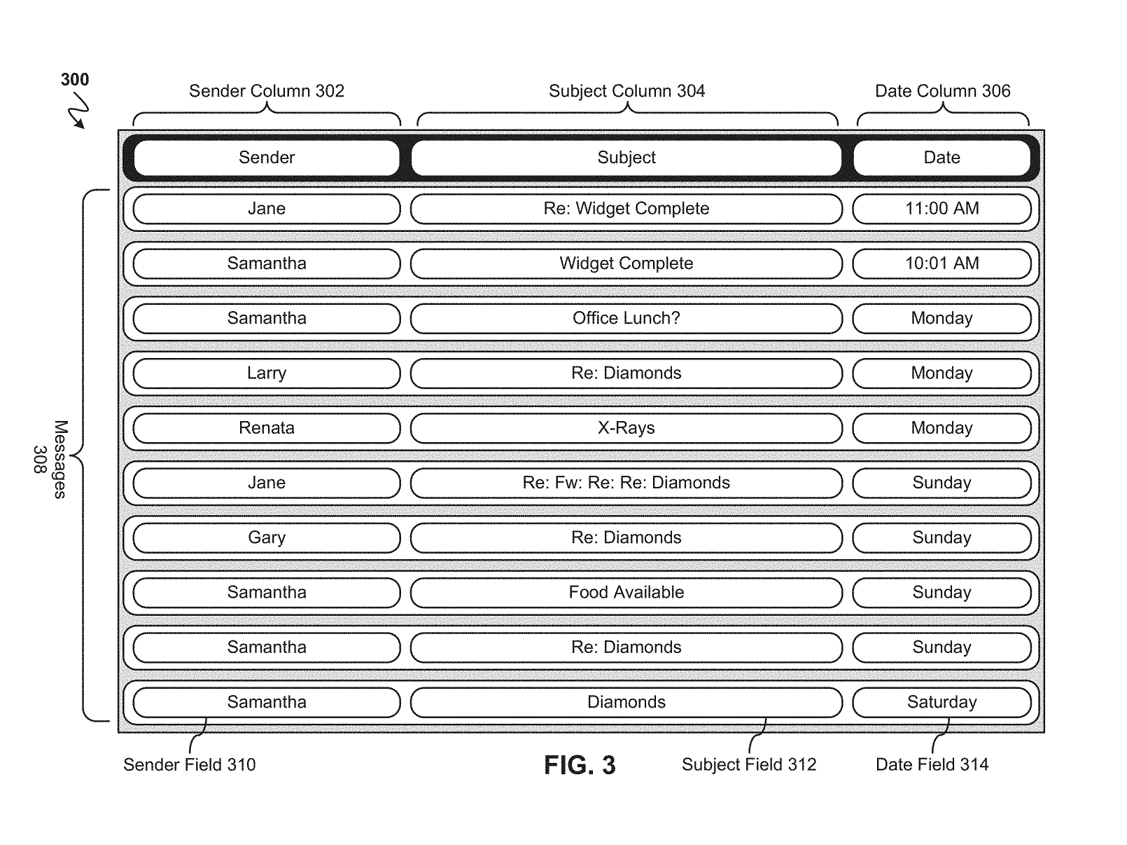

Additionally, visual indicators may be organized by field. In a vertical layout, vertical columns may be used to separate field values by fields. For example, for email messages having a sender field, a subject field, and a date field, the decomposed view may have three columns, one for each field. The visual indicators corresponding to the field values may then be placed in the decomposed view within the appropriate column. Thus, the visual indicator corresponding to “Samantha” will be placed within the column for the sender field. Additionally, visual indicators in columns may also be colored using a common shade of color (e.g., the visual indicators in the sender column may use various shades of red) to visually convey to the user that the field values are related by column. Decomposed layouts (i.e., decomposed views) will be shown in more detail with respect to FIGS. 3-5.

According to at least one other embodiment, synthetic elements may also be represented by visual indicators and added to the decomposed view. Synthetic elements may include natural language analysis, tables, paragraphs, lists, or sheets.

Then, at 212, the generated decomposed view is presented to the user. The decomposed view may then be presented to the user by displaying the decomposed view, for example, on a monitor screen or a screen on a mobile device. The decomposed view may be presented by the message handling program (e.g., email client), or the decomposed view may be presented by another program. Furthermore, the decomposed view may be presented over the messages (e.g., inbox) or list, or as a separate window. According to at least one implementation, the decomposed view may be presented as a semitransparent overlay on top of the messages or list.

According to at least one embodiment, after presenting the decomposed view, user interaction with the decomposed view may be monitored. The decomposed view may then dynamically react to the user interaction. User interaction (e.g., touching a touchscreen display, voice recognition, or clicking with a mouse) with the visual indicator for the sender “Samantha,” may result in regenerating and presenting the decomposed view to only show the other field values for messages having the sender field value of “Samantha.” According to at least one embodiment, user interaction may include a single swipe motion with the finger of the user moving across a touchscreen, whereby the user's finger passes over one visual indicator for each field (e.g., one sender visual indicator, one subject indicator, and one date indicator).

Referring now to FIG. 3, a block diagram illustrating an exemplary email client interface 300 according to at least one embodiment is depicted. The email client interface 300 includes a sender column 302, a subject column 304, and a date column 306. Displayed within the email client interface 300 are ten email messages 308. The sender column 302 displays sender field 310 data from the messages 308. Similarly, the subject column 304 displays subject field 312 data, and the date column 306 displays date field 314 data from the messages 308.

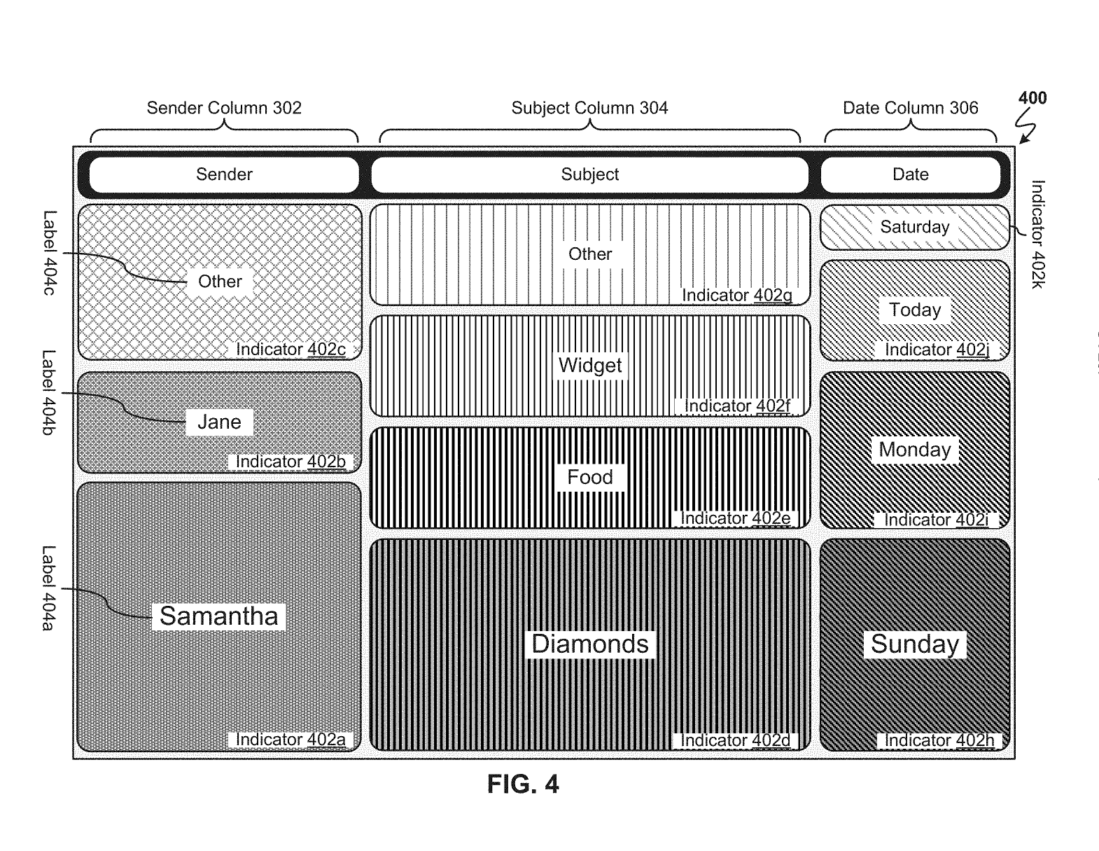

Referring now to FIG. 4, a block diagram illustrating an exemplary decomposed layout overlay 400 according to at least one embodiment is depicted. The decomposed layout overlay 400 is generated after analyzing the messages 308 using the decomposed layout generation process 200. Based on analyzing sender field 310 data as described above at 204 and extracting field data as described at 206, the decomposed layout generation process 200 will then determine the uniqueness for the data in each field as described previously at 208. The decomposed layout generation process 200 will determine that 50% of the sender field data contained the text string “Samantha,” 20% of the sender field data contained the text string “Jane,” and the final 30% contained text strings that only occurred once in the sender field 310 data. The same analysis, extraction, and determination will then proceed in a like manner for the subject field 312 data and the date field 314 data for all of the messages 308.

Then, the decomposed layout overlay 400 (i.e., decomposed view) is generated as described previously at 210. The decomposed layout overlay 400 uses rectangles as visual indicators 402a-k organized by column in a vertical orientation. The visual indicators 402a-k are sized based on the percentages calculated previously. Thus, the visual indicator 402a for the sender field 310 data corresponding to “Samantha” is sized to 50% of the vertical area available in the sender column 302 (minus area designated for spacing between visual indicators 402a-k). Furthermore, since “Samantha” accounted for the highest percentage of sender field 310 data, and is not a catchall category, the visual indicator 402a corresponding to “Samantha” is placed at the bottom of the sender column 302. According to at least one other embodiment, the visual indicator 402a may be placed at the top or some other position. The color (or pattern as shown) of the visual indicator 402a is also altered to signal more emphasis to the visual indicator 402a. Finally, the font size used for the visual indicator label 404a is increased (e.g., to size 18) as an additional visual cue indicating the sender field 310 data corresponding to “Samantha” occurred more than any other sender field 310 data.

Similarly, a visual indicator 402b corresponding to the sender field 310 data for “Jane” is sized to 20% of the vertical area available in the sender column 302 (minus area designated for spacing between visual indicators 402a-k). The color (or pattern) and label 404b font size for the visual indicator 402b is generated such that the emphasis is less than that of the visual indicator 402a corresponding to “Samantha” since “Samantha” was determined to have occurred more frequently. Additionally, the visual indicator 402b for “Jane” is positioned just above the visual indicator 402a for “Samantha” since “Jane” occurred less frequently than “Samantha,” yet “Jane” occurred more frequently than the next most frequent sender field 310 data value. Finally, the same analysis results in generating a catchall visual indicator 402c with the label 404c of “Other” taking the remaining vertical area available in the sender column 302 and placed above the visual indicator 402b for “Jane.” The same analysis leads to generating and placing the visual indicators 402d-g in the subject column 304 and generating and placing the visual indicators 402h-k in the date column 306. The resulting decomposed layout overlay 400 is then presented as described previously at 212 and shown in FIG. 4.

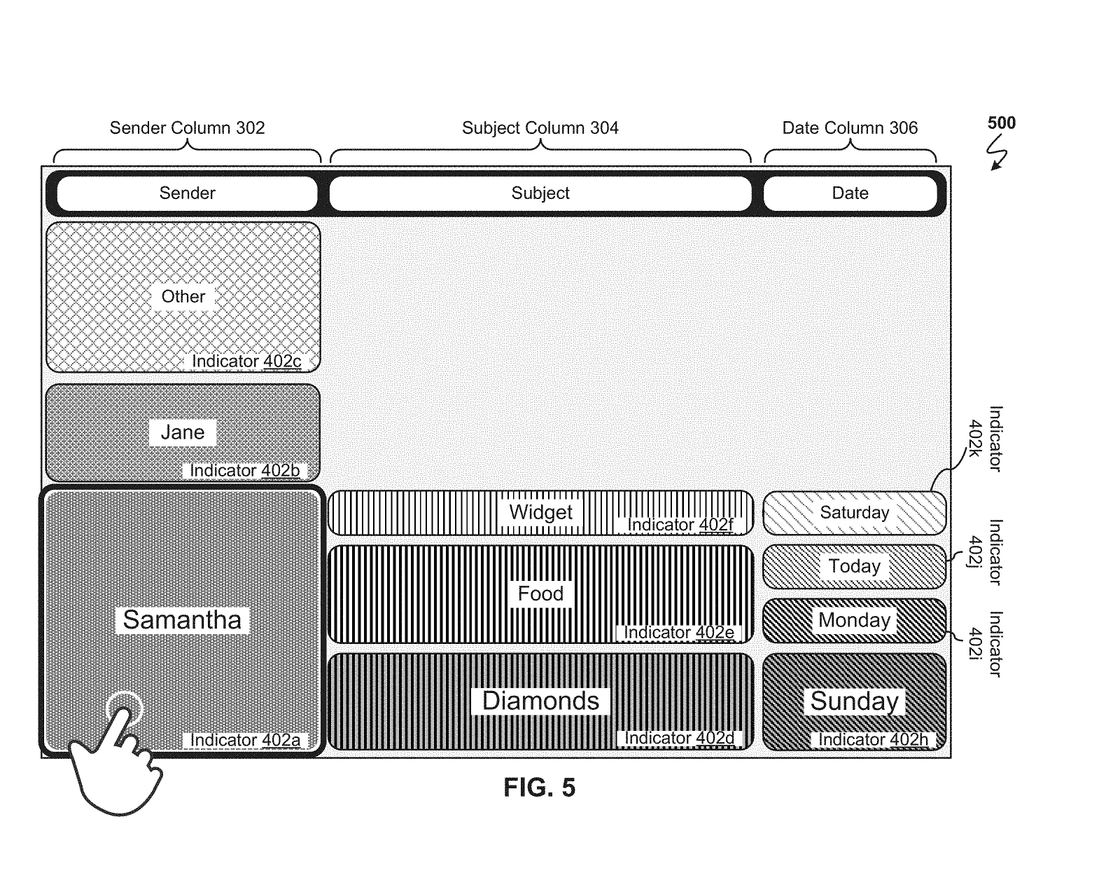

Referring now to FIG. 5, a block diagram illustrating an exemplary regenerated decomposed layout overlay 500 altered in response to a user selection according to at least one embodiment is depicted. After detecting the finger of the user touching a touchscreen region above the visual indicator 402a, the decomposed layout overlay 400 is altered and presented to the user as the regenerated decomposed layout overlay 500. Once user interaction is detected corresponding to visual indicator 402a “Samantha” in the sender column 302, the decomposed layout overlay 400 is altered to display only the visual indicators (i.e., 402d-f and 402h-k) in the other columns (i.e., subject column 304 and date column 306) that have sender field 310 data containing the text string “Samantha.” Thus, the uniqueness of the subject field 312 data and the date field 314 data for messages 308 containing sender field 310 data with the text string “Samantha” are recalculated as previously described at 208. Additionally, the available vertical area for each column is restricted to the vertical area used by visual indicator 402a. After recalculation and creating the regenerated decomposed layout overlay 500, the regenerated decomposed layout overlay 500 is then presented as described previously at 212 and as shown in FIG. 5.

It may be appreciated that FIGS. 2-5 provide only an illustration of one embodiment and do not imply any limitations with regard to how different embodiments may be implemented. Many modifications to the depicted embodiment(s) may be made based on design and implementation requirements. For example, field subsets for email senders may be determined by analyzing from/to/cc/bcc data from the emails. If too many subsets are generated (e.g., by exceeding a threshold), subsets may be generated for from/to/cc data and recursively thereafter to generate subsets for from/to data and finally for from data.

FIG. 6 is a block diagram 900 of internal and external components of computers depicted in FIG. 1 in accordance with an illustrative embodiment of the present invention. It should be appreciated that FIG. 6 provides only an illustration of one implementation and does not imply any limitations with regard to the environments in which different embodiments may be implemented. Many modifications to the depicted environments may be made based on design and implementation requirements.

Data processing system 902, 904 is representative of any electronic device capable of executing machine-readable program instructions. Data processing system 902, 904 may be representative of a smart phone, a computer system, PDA, or other electronic devices. Examples of computing systems, environments, and/or configurations that may represented by data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 and network server 112 may include respective sets of internal components 902 a, b and external components 904 a, b illustrated in FIG. 6. Each of the sets of internal components 902 a, b includes one or more processors 906, one or more computer-readable RAMs 908, and one or more computer-readable ROMs 910 on one or more buses 912, and one or more operating systems 914 and one or more computer-readable tangible storage devices 916. The one or more operating systems 914, the software program 108 and the decomposed layout program 110a in client computer 102, and the decomposed layout program 110b in network server 112 may be stored on one or more computer-readable tangible storage devices 916 for execution by one or more processors 906 via one or more RAMs 908 (which typically include cache memory). In the embodiment illustrated in FIG. 6, each of the computer-readable tangible storage devices 916 is a magnetic disk storage device of an internal hard drive. Alternatively, each of the computer-readable tangible storage devices 916 is a semiconductor storage device such as ROM 910, EPROM, flash memory or any other computer-readable tangible storage device that can store a computer program and digital information.

Each set of internal components 902 a, b also includes a R/W drive or interface 918 to read from and write to one or more portable computer-readable tangible storage devices 920 such as a CD-ROM, DVD, memory stick, magnetic tape, magnetic disk, optical disk or semiconductor storage device. A software program, such as the software program 108 and the decomposed layout program 110a and 110b can be stored on one or more of the respective portable computer-readable tangible storage devices 920, read via the respective R/W drive or interface 918, and loaded into the respective hard drive 916.

Each set of internal components 902 a, b may also include network adapters (or switch port cards) or interfaces 922 such as a TCP/IP adapter cards, wireless wi-fi interface cards, or 3G or 4G wireless interface cards or other wired or wireless communication links. The software program 108 and the decomposed layout program 110a in client computer 102 and the decomposed layout program 110b in network server computer 112 can be downloaded from an external computer (e.g., server) via a network (for example, the Internet, a local area network or other, wide area network) and respective network adapters or interfaces 922. From the network adapters (or switch port adaptors) or interfaces 922, the software program 108 and the decomposed layout program 110a in client computer 102 and the decomposed layout program 110b in network server computer 112 are loaded into the respective hard drive 916. The network may comprise copper wires, optical fibers, wireless transmission, routers, firewalls, switches, gateway computers and/or edge servers.

Each of the sets of external components 904 a, b can include a computer display monitor 924, a keyboard 926, and a computer mouse 928. External components 904 a, b can also include touch screens, virtual keyboards, touch pads, pointing devices, and other human interface devices. Each of the sets of internal components 902 a, b also includes device drivers 930 to interface to computer display monitor 924, keyboard 926, and computer mouse 928. The device drivers 930, R/W drive or interface 918, and network adapter or interface 922 comprise hardware and software (stored in storage device 916 and/or ROM 910).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

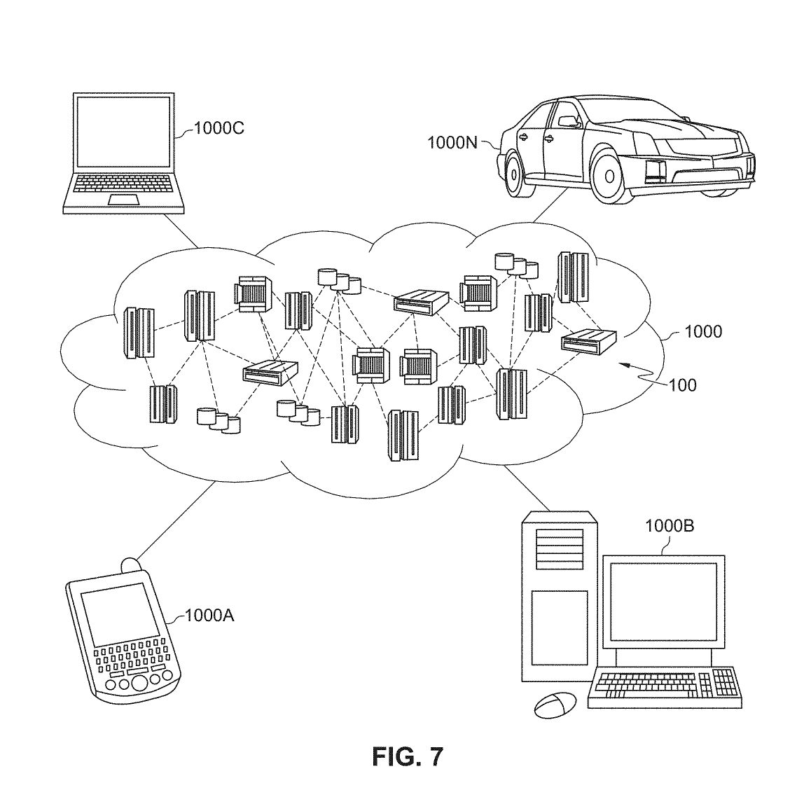

Referring now to FIG. 7, illustrative cloud computing environment 1000 is depicted. As shown, cloud computing environment 1000 comprises one or more cloud computing nodes 100 with which local computing devices used by cloud consumers, such as, for example, personal digital assistant (PDA) or cellular telephone 1000A, desktop computer 1000B, laptop computer 1000C, and/or automobile computer system 1000N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 1000 to offer infrastructure, platforms and/or software as services for which a cloud consumer does not need to maintain resources on a local computing device. It is understood that the types of computing devices 1000A-N shown in FIG. 7 are intended to be illustrative only and that computing nodes 100 and cloud computing environment 1000 can communicate with any type of computerized device over any type of network and/or network addressable connection (e.g., using a web browser).

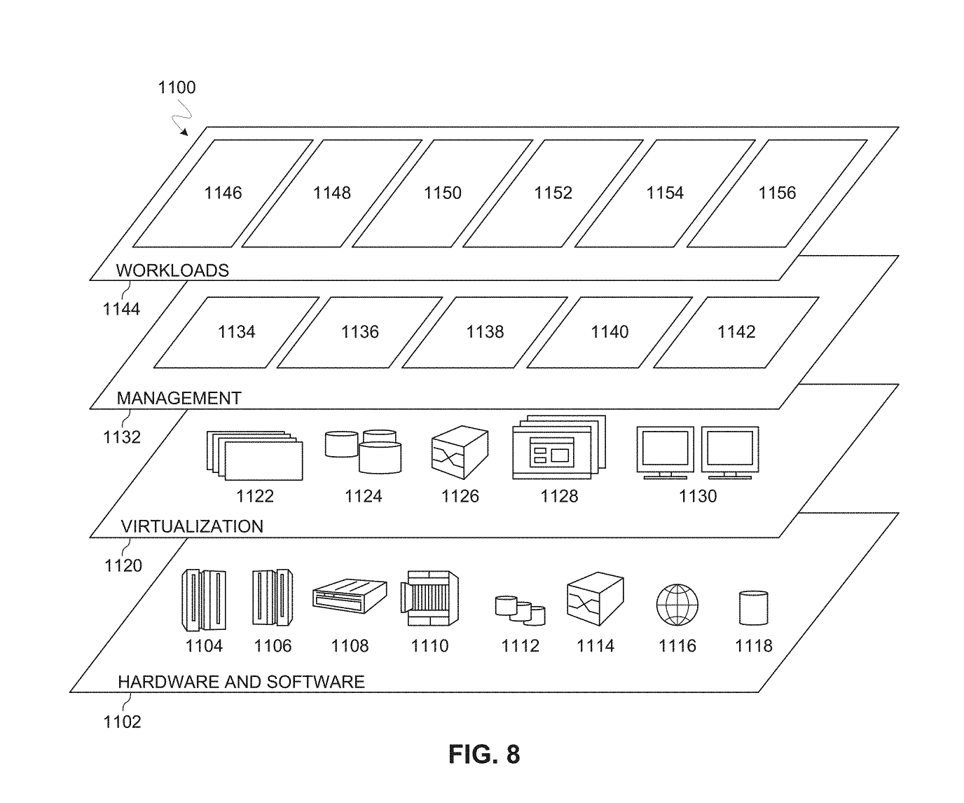

Referring now to FIG. 8, a set of functional abstraction layers 1100 provided by cloud computing environment 1000 is shown. It should be understood in advance that the components, layers, and functions shown in FIG. 8 are intended to be illustrative only and embodiments of the invention are not limited thereto. As depicted, the following layers and corresponding functions are provided:

Hardware and software layer 1102 includes hardware and software components. Examples of hardware components include: mainframes 1104; RISC (Reduced Instruction Set Computer) architecture based servers 1106; servers 1108; blade servers 1110; storage devices 1112; and networks and networking components 1114. In some embodiments, software components include network application server software 1116 and database software 1118.

Virtualization layer 1120 provides an abstraction layer from which the following examples of virtual entities may be provided: virtual servers 1122; virtual storage 1124; virtual networks 1126, including virtual private networks; virtual applications and operating systems 1128; and virtual clients 1130.

In one example, management layer 1132 may provide the functions described below. Resource provisioning 1134 provides dynamic procurement of computing resources and other resources that are utilized to perform tasks within the cloud computing environment. Metering and Pricing 1136 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 1138 provides access to the cloud computing environment for consumers and system administrators. Service level management 1140 provides cloud computing resource allocation and management such that required service levels are met. Service Level Agreement (SLA) planning and fulfillment 1142 provide pre-arrangement for, and procurement of, cloud computing resources for which a future requirement is anticipated in accordance with an SLA.

Workloads layer 1144 provides examples of functionality for which the cloud computing environment may be utilized. Examples of workloads and functions which may be provided from this layer include: mapping and navigation 1146; software development and lifecycle management 1148; virtual classroom education delivery 1150; data analytics processing 1152; transaction processing 1154; and decomposed layout generation 1156. A decomposed layout generation provides a way to distill information within message or lists and present the information visually to a user for attention management.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for presenting a plurality of electronic content based on a uniqueness criterion, the method comprising:
identify a plurality of content fields from the plurality of electronic content;
extracting a plurality of field data from the identified plurality of content fields;
determining the uniqueness criterion for each field within the extracted plurality of field data;
generating a plurality of visual indicators based on the identified plurality of content fields and the determined uniqueness criterion; and
presenting the generated plurality of visual indicators in a decomposed view on an electronic display.

2. The method of claim 1, wherein generating the plurality of visual indicators based on the identified plurality of content fields and the determined uniqueness criterion comprises tuning at least one visual characteristic of the plurality of visual indicators based on the identified plurality of content fields and the determined uniqueness criterion.

3. The method of claim 1, further comprising:
detecting a user interaction, wherein the detected user interaction is associated with a visual indicator within the plurality of visual indicators;
determining a new uniqueness criterion for each field within the extracted plurality of field data based on the visual indicator;
generating a plurality of altered visual indicators based on the identified plurality of content fields and the determined new uniqueness criterion; and
presenting the generated plurality of altered visual indicators on the electronic display.

4. The method of claim 1, wherein the plurality of electronic content is selected from a group consisting of a plurality of emails, a plurality of collaborative items, a plurality of instant messages, a plurality of short message services, at least one blog, at least one web page, at least one data list, and at least one news feed.

5. The method of claim 2, wherein the at least one visual characteristic is selected from a group consisting of an indicator size, an indicator color, a font size, an indicator pattern, an indicator position, an indicator color shade, and a font characteristic.

6. The method of claim 1, wherein the uniqueness criterion is determined by calculating a percentage of occurrences of the field within a content field category.

7. The method of claim 1, wherein generating a plurality of visual indicators based on the identified plurality of content fields and the determined uniqueness criterion comprises generating a visual indicator within the plurality of visual indicators for each unique content field within the identified plurality of content fields, wherein the generated visual indicator is positioned in the decomposed view based on a content field category associated with the unique content field and a number of occurrences associated with the unique content field.

8. A computer system for presenting a plurality of electronic content based on a uniqueness criterion, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
identifying a plurality of content fields from the plurality of electronic content;
extracting a plurality of field data from the identified plurality of content fields;
determining the uniqueness criterion for each field within the extracted plurality of field data;
generating a plurality of visual indicators based on the identified plurality of content fields and the determined uniqueness criterion; and
presenting the generated plurality of visual indicators in a decomposed view on an electronic display.

9. The computer system of claim 8, wherein generating the plurality of visual indicators based on the identified plurality of content fields and the determined uniqueness criterion comprises tuning at least one visual characteristic of the plurality of visual indicators based on the identified plurality of content fields and the determined uniqueness criterion.

10. The computer system of claim 8, further comprising:
detecting a user interaction, wherein the detected user interaction is associated with a visual indicator within the plurality of visual indicators;
determining a new uniqueness criterion for each field within the extracted plurality of field data based on the visual indicator;
generating a plurality of altered visual indicators based on the identified plurality of content fields and the determined new uniqueness criterion; and
presenting the generated plurality of altered visual indicators on the electronic display.

11. The computer system of claim 8, wherein the plurality of electronic content is selected from a group consisting of a plurality of emails, a plurality of collaborative items, a plurality of instant messages, a plurality of short message services, at least one blog, at least one web page, at least one data list, and at least one news feed.

12. The computer system of claim 9, wherein the at least one visual characteristic is selected from a group consisting of an indicator size, an indicator color, a font size, an indicator pattern, an indicator position, an indicator color shade, and a font characteristic.

13. The computer system of claim 8, wherein the uniqueness criterion is determined by calculating a percentage of occurrences of the field within a content field category.

14. The computer system of claim 8, wherein generating a plurality of visual indicators based on the identified plurality of content fields and the determined uniqueness criterion comprises generating a visual indicator within the plurality of visual indicators for each unique content field within the identified plurality of content fields, wherein the generated visual indicator is positioned in the decomposed view based on a content field category associated with the unique content field and a number of occurrences associated with the unique content field.

15. A computer program product for presenting a plurality of electronic content based on a uniqueness criterion, comprising:
one or more computer-readable storage medium and program instructions stored on at least one of the one or more tangible storage medium, the program instructions executable by a processor, the program instructions comprising:
program instructions to identify a plurality of content fields from the plurality of electronic content;
program instructions to extract a plurality of field data from the identified plurality of content fields;
program instructions to determine the uniqueness criterion for each field within the extracted plurality of field data;
program instructions to generate a plurality of visual indicators based on the identified plurality of content fields and the determined uniqueness criterion; and
program instructions to present the generated plurality of visual indicators in a decomposed view on an electronic display.

16. The computer program product of claim 15, wherein generating the plurality of visual indicators based on the identified plurality of content fields and the determined uniqueness criterion comprises tuning at least one visual characteristic of the plurality of visual indicators based on the identified plurality of content fields and the determined uniqueness criterion.

17. The computer program product of claim 15, further comprising:
program instructions to detect a user interaction, wherein the detected user interaction is associated with a visual indicator within the plurality of visual indicators;
program instructions to determine a new uniqueness criterion for each field within the extracted plurality of field data based on the visual indicator;
program instructions to generate a plurality of altered visual indicators based on the identified plurality of content fields and the determined new uniqueness criterion; and
program instructions to present the generated plurality of altered visual indicators on the electronic display.

18. The computer program product of claim 16, wherein the at least one visual characteristic is selected from a group consisting of an indicator size, an indicator color, a font size, an indicator pattern, an indicator position, an indicator color shade, and a font characteristic.

19. The computer program product of claim 15, wherein the uniqueness criterion is determined by calculating a percentage of occurrences of the field within a content field category.

20. The computer program product of claim 15, wherein generating a plurality of visual indicators based on the identified plurality of content fields and the determined uniqueness criterion comprises generating a visual indicator within the plurality of visual indicators for each unique content field within the identified plurality of content fields, wherein the generated visual indicator is positioned in the decomposed view based on a content field category associated with the unique content field and a number of occurrences associated with the unique content field.
